(19) United States
(12) Patent Application Publication
(10) Pub. No.: US 2003/0073580 A1
(43) Pub. Date: Apr. 17, 2003

(54) Composition for treating cells and method for qualitatively and quantitatively customizing the formulation thereof

(76) Inventor: Walter H. Runkis, Monroe, CT (US)

Correspondence Address: Walter H. Runkis, 78 Lantern Drive, Monroe, CT, 06468, US

(21) Appl. No.: 09/880,322

(22) Filed: Jun. 13, 2001

(51) Int. Cl. A01N 47/28

(52) U.S. Cl. 504/148

(57) ABSTRACT

The instant invention relates to a composition of solution stable Ca⁺⁺, Mg⁺⁺, N³⁻, and S⁶⁺ moieties and a method of varying the quantitative proportions of at least the solution stable Ca⁺⁺ and Mg⁺⁺ moieties in the composition. In its more complex expression, the invention provides a composition that includes compensating proportions of substantially any of the essential micronutrients or macronutrients in a solution stable form. In a first preferred embodiment, the invention has utility as a soil treatment composition. In a second preferred embodiment, the invention has utility as a cell culture medium. The invention further contemplates the recovery of a substantially pure CO₂ product formed by the reaction process that produces the instant composition.

### BACKGROUND OF THE INVENTION

In its broadest expression, the present invention relates to a composition of matter for beneficially treating cells and to a substantial degree, a method for quantitatively customizing its formulation. More specifically, the invention relates to a composition of mineral compounds and a method of customizing the quantitative proportions of at least several of these compounds in the composition, e.g., providing substantially any combination of water solution stable macronutrients and/or micronutrients of substantially any concentration and/or concentrations. On its most fundamental level, the instant invention relates to a composition for feeding higher plants with a nutrient mixture having solution stable Ca⁺⁺, Mg⁺⁺, N³⁻, and S⁶⁺ moieties. On this level, it also relates a method of varying the quantitative proportions of at least the solution stable Ca⁺⁺ and Mg⁺⁺ moieties in the composition. On a more complex level, the invention may be practiced to customize the formulation of the instant composition. This is done so as to accommodate deficiencies of most, if not all of the known essential macronutrients and/or micronutrients, specific to an individual soil sample. In an alternate embodiment, the composition is useful as a cell culture medium to feed any and/or all living cells, including animal and plant cells.

It is well known that plants need water, air, light, suitable temperature, and nineteen nutrients to grow. Plants get carbon, hydrogen and oxygen from air and water. The other sixteen nutrients come from the soil. Soilborne nutrients are divided into two groups according to the amounts needed by higher plants. The Macronutrients are nitrogen, potassium, calcium, phosphorus, sulfur, and magnesium. The Micronutrients, which are needed in lesser amounts, are iron, manganese, boron, zinc, copper, molybdenum, sodium, cobalt, chlorine, and nickel. These nutrients are generally considered essential for the growth and reproduction of most plants.

Cells will grow normally until they run short of one or more nutrients. Growth is then limited by deficiency. When nutrients are deficient, or over abundant to toxic levels, cells will atrophy, lack vitality, and/or be unable to maintain optimal metabolic functionality. Observable symptoms may indicate which nutrient or nutrients are deficient, but observation alone does not always prove expedient. Various assays must often be employed to determine if nutrients are in short supply before observable symptoms appear. In most cases, it is better to supply a constant sufficiency of all required nutrients to prevent the onset of deficiencies since even minor deficiencies, especially during early stages of development, can adversely affect growth and reproduction over the entire lifespan of the organism.

Mixing concentrated solution stable nutritional compositions, especially those designed to feed autotrophs, is problematic. Autotrophs, such as higher plants, have the ability to convert simple mineral ions into complex organic metabolites. The instant invention solves a major problem presently plaguing agronomists. This problem arises from the need to feed higher plants with relatively high concentrations of both Calcium and Sulfur. Mixing concentrated nutritional compositions that contain ample quantities of both Calcium and Sulfur is problematic since divalent Calcium cations and divalent Sulfur anions, such as SO₄⁻⁻ radicals, readily combine to form CaSO₄, i.e., Calcium sulfate or gypsum. This compound is nearly insoluble in water at neutral pH. For example, Calcium nitrate and Magnesium sulfate are commonly used as agricultural sources of Calcium and Sulfur. These compounds readily react upon contact according to the following equation:

Ca(NO₃)₂+MgSO₄→CaSO₄+Mg(NO₃)₂

Mixing solution stable compositions containing all Sixteen (16) essential nutrients, including relatively high concentrations of both Calcium and Sulfur, is especially important when creating nutritional compositions designed to grow plants using hydroponic or soilless techniques.

Charged ions by their nature are chemically reactive. Ions that are of nutritional value to higher plants must be maintained in aqueous solution so to be transported through the xylem and phloem, i.e., the circulatory systems of higher plants. Such aqueous solutions are also required so as to actively transport ions across cellular membranes surrounding the cytoplasm and organelles. The instant invention addresses these problems by teaching a method of combining relatively high concentrations of Calcium, and other cations, with relatively high concentrations of nutritional Sulfur anions.

The Macronutrients

Nitrogen, N, stimulates leaf and stem growth. Nitrogen deficiency causes reduced growth and pale yellowish green leaves. The older leaves turn yellowish first since the nitrogen is readily moved from the old leaves to the new growth. If the soil is cold and wet, nitrogen in the soil is not as available to the plants. Excess nitrogen may cause potassium deficiency.

Potassium, K, promotes general vigor, disease resistance and sturdy growth. Potassium deficiency causes stunted growth with leaves close together. Starting with the older leaves, the leaf tips and edges turn scorched brown and leaf edges roll. Excess potassium may cause calcium and magnesium deficiencies.

Calcium, Ca, is a major ingredient in cell walls and is important for root growth, especially root tips. Calcium deficiency causes poorly developed roots with weak tips. Leaves are distorted with hooked tips and curled margins. Furthermore, since calcium is immobilized in older tissue and is not translocatable to newer tissues, deficiencies may exist that are localized in the most recently developed tissue and not uniformly present throughout the plant.

Phosphorus, P, is important in the germination and growth of seeds, the production of flowers and fruit, and the growth of roots. Phosphorus deficiency causes reduced growth and small leaves that drop early, starting with the oldest leaves. Leaf color is a dull, bluish green that becomes purplish or bronzy. Leaf edges often turn scorched brown. Excess phosphorus may cause potassium deficiency.

Sulfur, S, is a vital component in protein synthesis where disulfide bonds provide structural bonds that give each protein its unique conformation. Sulfur is also necessary for chlorophyll formation. Sulfur deficiency causes slow growth with small round leaves that roll upward and are stiff and brittle. Leaves drop off and tip buds die.

Magnesium, Mg, is vital to chlorophyll production and is important in most enzyme reactions. Magnesium deficiency causes different symptoms in different plants, but commonly includes leaf yellowing with brilliant tints. Leaves may suddenly drop off without withering. Symptoms show first on older leaves. Excess magnesium may cause calcium deficiency.

The Micronutrients

Iron, Fe, is necessary for chlorophyll formation and for oxygen transfer. Iron deficiency causes leaf yellowing while leaf veins stay green. Younger leaves are affected first. Excess lime may cause iron deficiency.

Manganese, Mn, is a catalyst for many enzymes and is important for chlorophyll formation. Manganese deficiency causes different symptoms in different plants, but commonly causes leaves to turn yellow while veins stay green. White or gray specks may appear on leaves. Older leaves are affected first. Excess manganese may cause iron deficiency and may cause symptoms similar to manganese deficiency.

Boron, B, is necessary for the movement of sugars, for reproduction, and for water intake by cells. It also tends to keep calcium in a soluble form. Boron deficiency causes distorted and dead growing tips, hollow stems and deformed fruit. Leaves are often scorched and curled and sometimes mottled and discolored. Young leaves are affected first. Excess boron may cause scorched leaf edges similar to potassium or magnesium deficiencies.

Zinc, Zn, is necessary for the production of proteins and affects plant size and maturity. Zinc deficiency causes leaf yellowing between the veins, usually with purple or dead spots starting with the older leaves. Leaves are close together, small and deformed. Fruiting is reduced. Excess zinc may cause iron deficiency.

Copper, Cu, is necessary for the production of proteins and is important for reproduction. Copper deficiencies causes bluish green leaves, which may wither or fail to unfold. Younger leaf tips may be yellow at the edge. Growing tips may form rosettes. Excess copper may cause iron deficiency.

Molybdenum, Mo, is essential to nitrate enzymes and for the formation of root nodules in beans and peas. Molybdenum deficiencies cause yellow mottling and dead spots on the leaves. In some plants, the growing tips are distorted or killed.

Chlorine, Cl, may affect carbohydrate metabolism and photosynthesis. Chlorine deficiencies may cause stubby roots and wilting. Excess chlorine may cause leaf edges to scorch similar to potassium deficiency.

Sodium, Na, is required by certain plants, such as halophytes, which will not grow without it.

Cobalt, Co, has been shown to have utility in the formation of lignocellulose where it works in conjunction with molybdenum. Lignocellulose is a major constituent of bark and provides “sturdiness” in plants. Cobalt is also necessary in the fixation of atmospheric nitrogen by symbiotic root-nodule bacteria.

Nickel, Ni, is a component of several enzymes, especially urease. Urease functions to break down urea.

Typical Concentrations of Various Nutrients.

The following table illustrates typical nutrients required by a diversity of crops:

TABLE 1
Typical concentrations sufficient for plant growth. After E. Epstein.
1965. “Mineral metabolism” pp. 438-466. in: Plant
Biochemistry (J. Bonner and J. E. Varner, eds.) Academic Press, London.

| Element | Symbol | Mg/Kg | Percent | Relative |
|---|---|---|---|---|
| Nitrogen | N | 15,000 | 1.5 | 1,000,000 |
| Potassium | K | 10,000 | 1.0 | 250,000 |
| Calcium | Ca | 5,000 | 0.5 | 125,000 |
| Magnesium | Mg | 2,000 | 0.2 | 80,000 |
| Phosphorus | P | 2,000 | 0.2 | 60,000 |
| Sulfur | S | 1,000 | 0.1 | 30,000 |
| Chlorine | Cl | 100 | — | 3,000 |
| Iron | Fe | 100 | — | 2,000 |
| Boron | B | 20 | — | 2,000 |
| Manganese | Mn | 50 | — | 1,000 |
| Zinc | Zn | 20 | — | 300 |
| Copper | Cu | 6 | — | 100 |
| Molybdenum | Mo | 0.1 | — | 1 |
| Sodium | Na | <0.1 | — | <1 |
| Cobalt | Co | <0.1 | — | <1 |
| Nickel | Ni | <0.1 | — | <1 |

Nutrient Depletion and Nutrients Compatibility in Higher Plants

Both macro- and micronutrients are lost from soil in a number of ways. These ways include, but are not necessarily limited to: general soil depletion, over cultivation, soil erosion, liming, excess nitrate, incompatible fertilizer mixtures, atmospheric damage, poor land management, and the like.

By way of example, nitrogen loss can occur through removal by various crops. A wheat crop of 2000 kg/ha (kilograms/hectare) will remove about 50 kg of N/ha in the grain. A 2000 kg/ha crop of canola will remove as much as 70 kg of N/ha in the seed. If the straw from the 2000 kg/ha wheat crop is burned, a loss of 15 kg N/ha to the atmosphere will result. Nitrogen can also be lost when fertilizers such as ammonia or urea are lost when unfavorable soil conditions exist. For example if urea is applied to a soil surface with trash cover and the soil is dry, up to 40% can be lost before the rest of the urea is washed into the soil. Under waterlogged conditions in the presence of organic matter, soil microorganisms (autotrophs) can covert soil nitrate to nitrogen gases such as NO, N₂O and N₂ that are lost to the atmosphere through a process called denitrification. Otherwise, urea fertilizer and soil nitrate are very mobile in soil solution and can be washed down the soil profile by heavy precipitation. This process is known as leaching. Much of this nitrogen finds its way into aquifers, streams and lakes contaminating waterways and drinking water. Great care is needed in applying fertilizer nitrogen so that this source of pollution is minimized. As noted above, nitrogen is used here merely by way of example. Several of the foregoing processes of loss are also applicable to others of the essential plant macronutrients and micronutrients.

Like many chemical mixtures derived from multiple chemical sources, blending a solution stable plant fertilizer that comprises a “complete” mixture containing proper concentrations of all sixteen soilborne essential plant nutrients is problematic. Furthermore, for a fertilizer product to be commercially practical it is essential to maintain such a mixture in a solution stable state for a relatively long shelf-life period. Currently, commercial fertilizers do not contain all sixteen soilborne macronutrients and micronutrients in concentrations sufficient to satisfy United States Department of Agriculture (“USDA”) requirements for inclusion on a product's label under the “Guaranteed Analysis” section. At best, fertilizers contain a combination of Nitrogen Phosphorus and Potassium (“NPK”). Some may also contain either Ca or S, but never Ca and S in concentrations sufficient to satisfy USDA labeling requirements for listing. This is at least attributable to the difficulty in combining calcium and sulfur in a solution stable state. Although the use of sulfates (e.g., magnesium sulfate) is quite common, there is a tendency for calcium and sulfate to bond and form water insoluble precipitates such as calcium sulfate or gypsum. This is especially problematic for fertilizer manufacturers.

There are numerous reasons why most forms of sulfur are not suitable for plant consumption. For example, elemental sulfur must be digested by microorganisms to be converted to a plant consumable form such as sulfate. This process can take up to three (3) months. Thiosulfate reacts with acids, reagents, metals, and light, degrading to S, SO₂, SO₃ and SO₄. There are also compatibility problems between Sulfur and other nutrients, such as phosphates and metallic divalent cations like iron, zinc, copper and manganese. In order to avoid these problem, chelated metals are often included in fertilizer mixtures. However, chelates such as EDTA (ethylenedinitrilotetraacetic acid) are more costly, and have a large number of binding sites to attract water relative to the number of water binding sites common to the nutrient ions which they carry. This effectively reduces the amount of water available to other nutrient ions, thereby limiting the solution concentrations achievable for less soluble ions in a mixture.

It is clear from the foregoing, that it would be of great advantage to agronomists and fertilizer manufacturers to add solution stable Ca⁺⁺, Mg⁺⁺, N³⁻, and S⁶⁺ and other micronutrients moieties to specific areas of soil in more or less predictable water solution stable amounts. It would be of further advantage to add substantially any of the known essential macronutrients and micronutrients to a soil treatment composition in substantially any water solution stable predictable amount.

In an alternate embodiment, the invention contemplates the use of the novel composition as a cell growth medium for cell culture and tissue engineering purposes. The invention describes a concentrated culture medium composition packaged as a stock solution or in a unit dose form. The unit dose form includes an amount of cell culture medium in dry or liquid form sufficient to prepare a preselected amount of culture medium. Preferably, the unit dose packaging is in the form of a liquid stock solution packet or ampuole, or a capsule containing the dry culture medium. In an alternate embodiment, the dry culture medium is packaged in a unit dose package that is comprised of a dissolvable material. The composition is effective in regard to the culturing of any living cells, including both plant and/or animal cells.

### BRIEF DESCRIPTION OF THE DRAWING

FIG. 1 is a chart illustrating the relationship between sulfur uptake in plant tissue and the conversion of free nitrate into organic nitrogen and protein nitrogen.

### DETAILED DESCRIPTION OF THE DRAWING

Nitrate Consumption as a Function of Sulfur Uptake in Plant Protein Synthesis

Sulfur plays a vital role in the physiology of all living organisms where it serves as a component or cofactor in several metabolic processes. For example, it is a constituent of certain “essential amino acids” (amino acids that cannot be synthesized by animals) such as methionine, an amino acid that facilitates biological transmethylation processes. It is also responsible for the formation of disulfide bonds during protein synthesis. Disulfide bonds are an important “internal glue” that gives each protein its unique conformation and functionality. Recent research has also revealed that sulfur plays a vital role in the formation of certain enzymes (protein catalysts) as evidenced by the following paragraph.

“It is currently assumed that the assimilation of sulfur into reduced forms occurs predominantly in the leaves of plants. However, developing seeds have a strong requirement for sulfur amino acids for storage protein synthesis. We have assessed the capacity of developing seeds of narrow-leaf lupin (Lupinus angustifolius) for sulfur assimilation. Cotyledons of developing lupin seeds were able to transfer the sulfur atom from 35S-labeled sulfate into seed proteins in vitro, demonstrating the ability of the developing cotyledons to perform all the steps of sulfur reduction and sulfur amino acid biosynthesis. Oxidized sulfur constituted approximately 30% of the sulfur in mature seeds of lupins grown in the field and almost all of the sulfur detected in phloem exuded from developing pods. The activities of three enzymes of the sulfur amino acid biosynthetic pathway were found in developing cotyledons in quantities theoretically sufficient to account for all of the sulfur amino acids that accumulate in the protein of mature lupin seeds. We conclude that sulfur assimilation by developing cotyledons is likely to be an important source of sulfur amino acids for the synthesis of storage proteins during lupin seed maturation.” (Plant Physiology, May 2001, Vol. 126, pp. 176-187)

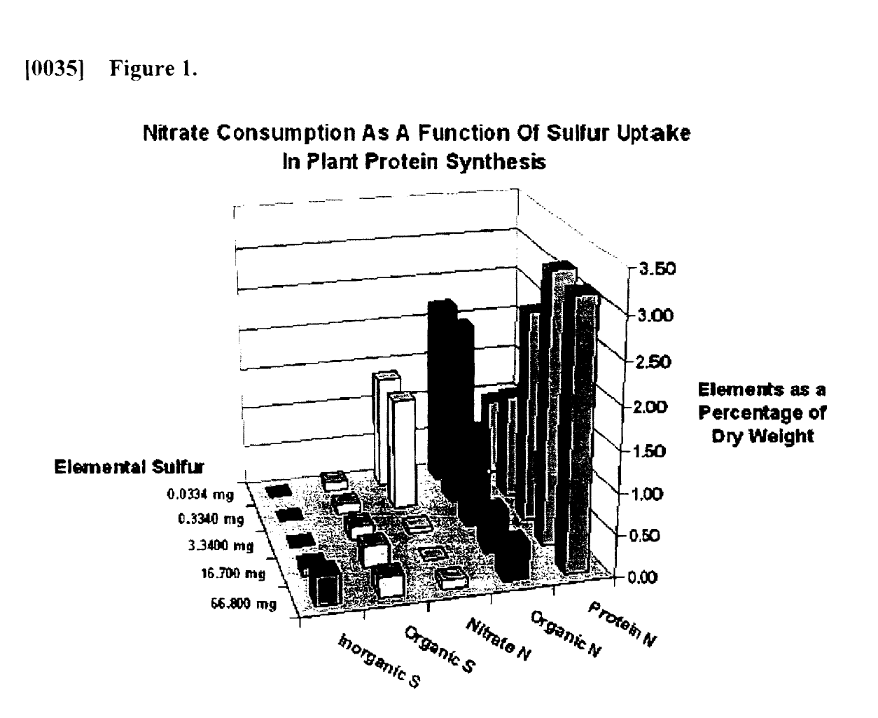

It has also been reported (Mineral Nutrition of Higher Plants, Marchner, H., Academic Press, London; 2nd Edition 1996.) that as the concentration of available sulfur is increased in a fertilizer mixture to an optimal concentration of approximately 16.7 mg per liter, free nitrate nitrogen in plant leaves drops to zero. At the same time, organic sulfur and protein nitrogen increase to their maximum as they are converted into plant tissue through the process of protein synthesis, see Table 2 and FIG. 1, below. These data adequately demonstrate that while plant tissues may contain large amounts of NO₃ radicals available for protein synthesis, this source of nitrogen cannot be converted to organic nitrogen and protein nitrogen without an adequate supply of available sulfur.

TABLE 2
Sulfur in Fertilizer Supply

| Sulfate | Milligrams | Sulfate and Nitrogen as Percentage of Dry Weight | | | | | Leaf Dry Wt |
|---|---|---|---|---|---|---|---|
| Mg SO4/ L | Elemental S | Inorganic S | Organic S | Nitrate N | Organic N | Protein N | g/plant |
| 0.1 | 0.0334 | 0.003 | 0.11 | 1.39 | 2.23 | 0.96 | 1.1 |
| 1.0 | 0.3340 | 0.003 | 0.12 | 1.37 | 2.21 | 1.28 | 2.4 |
| 10.0 | 3.3400 | 0.009 | 0.17 | 0.06 | 1.19 | 2.56 | 3.4 |
| 50.0 | 16.7000 | 0.100 | 0.26 | 0.00 | 0.51 | 3.25 | 4.7 |
| 200.0 | 66.8000 | 0.360 | 0.25 | 0.10 | 0.45 | 3.20 | 4.7 |

### SUMMARY OF THE INVENTION

The Basic Reaction

The instant invention purports in great measure to provide these advantages to the agronomist and fulfill a long felt need. On its most basic level, the invention provides a composition that includes at least Four (4) and up to all Six (6) macronutrients, and up to all of the essential micronutrients in an aqueous solution stable form. The basic reaction proceeds as follows:

Dolomite (Calcium/Magnesium carbonate)+Sulfamic acid→Calcium sulfamate+Magnesium sulfamate→water+carbon dioxide↑

The reaction proceeds as a simple substitution. The relative proportions of Calcium carbonate to Magnesium carbonate may be varied without upsetting the stoichiometric balance of the equation. Thus, through the addition of limestone or Magnesite to the Dolomite reactant, its proportions may be varied to render all respective quantitative proportions of Calcium sulfamate to Magnesium sulfamate, e.g., an all Calcium sulfamate product; or, an all Magnesium sulfamate product; or, a product containing any relative proportion of Calcium sulfamate to Magnesium sulfamate or visa versa. On a more complex level of the invention, any Sulfamic acid derivative may be substituted for the Sulfamic acid reactant of the basic reaction that renders a water solution stable salt product.

On another more complex level, any or any combination of, the below listed Carbonates/Hydroxides/Carbonate-Hydroxides/Carbonate-Hydroxide-Oxides/ and/or powdered metals may be added in a predetermined proportion to the Dolomite reactant of the basic reaction in order to compensate for substantially any macronutrient/micronutrient deficiency of a particular soil sample. Thus, in this manner, the composition may be “customized” to accommodate substantially any macronutrient or micronutrient deficiency. Without departing from the spirit of the invention, the composition formulation may also be “customized” by merely adding predetermined proportions of commercially available micronutrient/macronutrient sulfamates to the basic reaction product, rather than reacting with the above described materials.

In a first preferred embodiment, compositions prepared through the practice of the instant invention are useful as fertilizers and/or fertilizer additives to grow plants that are higher on the biological scale. In a second preferred embodiment, compositions prepared through the practice of the instant invention are useful as cell growth media to amplify any living cell, including but not limited to: animal cells, mammalian cells, bacteria, yeast, fungi, and plant cells, i.e., living cells on the lower end of the biological scale.

Various related sulfamic acid/derivatives and/or dolomite/limestone technology has been proposed by the prior art as exemplified by the following United States Patents. These are incorporated herein in their entireties for purposes of enabling the person of ordinary skill in the art to practice the instant invention.

U.S. Pat. Nos. 5,597,512 and 5,221,497 teach magnesium and/or calcium sulfamates as useful in the preparation of silica sol. Various sulfamic acid derivatives and their diverse uses are disclosed at U.S. Pat. Nos. 6,156,768, 6,117,909, 5,662,940, 5,602,119, 5,527,547, 5,476,670, 5,464,636, 5,260,135, 5,204,345, 5,180,735, 4,933,056, 4,650,902 and 4,016,051. A diversity of dolomite species is disclosed at U.S. Pat. No. 4,032,305. U.S. Pat. Nos. 5,658,790, 6,209,259, 5,871,999, 5,776,778, 5,529,920, 5,500,229, 5,342,777, 5,232,848, 5,135,866 and 4,927,762, 4,816,401 all show cell culture media.

### OBJECTS OF THE INVENTION

The instant invention in large part solves the problems of the prior art and fulfills a long felt need by providing a composition of solution stable Ca⁺⁺, Mg⁺⁺, N³⁻, and S⁶⁺ moieties. It fulfills a second long felt need by providing a method of varying the quantitative proportions of at least the solution stable Ca⁺⁺ and Mg⁺⁺ moieties in the composition. Optionally, the invention may be practiced to add at least one substantially pure powdered metal and/or hydroxide and/or carbonate and/or carbonate-hydroxide and/or carbonate-hydroxide-oxide of a known essential micronutrient and/or macronutrient, in order to predictably alter the quantitative proportions of the composition to compensate for the deficiencies of a known soil sample. As a further option, the invention may be practiced to substitute more complex derivatives of sulfamic acid for the sulfamic acid reactant of the basic reaction.

In a first preferred embodiment, it is a primary object of the invention to provide compositions useful as fertilizers or fertilizer additives. In a second preferred embodiment, it is a primary object of the invention to provide compositions useful as cell growth media effective in the culturing of any and/or all living cells, including plant cells, animal cells and other living cells having the characteristics of both plant and animal. Other objects, features, and advantages of the instant invention, in its details, will be seen from the above, and from the following description of the preferred embodiments when considered in light of the appended claims.

### DETAILED DESCRIPTION OF THE INVENTION

The Reactions

The Basic Sulfamic Acid/Dolomite Reaction

The basic reaction that produces the basic composition of the instant invention is:

CaCO₃+MgCO₃+4 HSO₃NH₂→Ca(SO₃NH₂)₂+Mg(SO₃NH₂)₂+2CO₂↑+2H₂O (Eq. 1)

wherein dolomite (CaMg(CO₃)₂) is reacted with sulfamic acid or any of its derivatives that render water solution stable Ca⁺⁺([SO₃NH₂]⁻)₂+Mg⁺⁺([SO₃NH₂]⁻)₂, a substantially pure CO₂, and water. The dolomite can be of any known grade. Optionally, the dolomite may be combined with at least one member of the group consisting of any known grade of: limestone, magnesite, lime, slaked lime, magnesium oxide and combinations thereof. It must be noted here, that dolomite, as defined herein, is a naturally occurring substance.

Sulfamic Acid Derivatives

In its broadest expression, the invention contemplates the use of sulfamic acid and/or any of its derivatives that will react with dolomite or any combination of its equivalents as defined herein, to produce a water solution stable salt. The sulfamic acid or derivative thereof (which may be referred to as the “sulfamic acid compound” or “the sulfamic acid reactant”) is preferably sulfamic acid itself but may otherwise be any derivative thereof, that can be reacted with dolomite or any combination of its equivalents as defined herein to provide a water solution stable salt that includes a macronutrient and/or micronutrient moiety or combinations thereof, as defined herein.

Although the invention contemplates Sulfamic acid and/or any of its derivatives, and/or any combination thereof, that react to provide water solution stable products, the a preferred derivative in the practice of the invention (i.e., the sulfamic acid reactant or sulfamic acid compound) is typically a compound of the formula (I):

HSO₃NR⁴R⁵ (I)

Wherein:

R⁴ and R⁵ are independently selected from the group consisting of hydrogen and a hydrocarbyl group.

Preferred derivatives of sulfamic acid are water-soluble compounds in which the hydrocarbyl group is (are) hydrocarbon hydrocarbyl and the total number of carbon atoms is from 1 up to and including about 12. However, sulfamic acid itself (R⁴═R⁵═H) is most preferred.

In this application, the term “hydrocarbyl” will be used, and for the purposes of definition, will preferably include hydrocarbons which render a water soluble derivative, as well as substantially hydrocarbon groups. Substantially hydrocarbon describes groups which contain hetero atom constituents which alter the predominantly hydrocarbon nature of the group to the extent of causing the end product to be water soluble. Typically hydrocarbyl groups include, but are not necessarily limited to the following: (1) hydrocarbon constituents, that is aliphatic (e.g., alkyl or alkenyl), alicyclic (e.g., cycloalkyl, cycloalkenyl) constituents, aromatic-substituted aliphatic constituents or aromatic-substituted alicyclic constituents, or aliphatic- and alicyclic-substituted aromatic constituents and the like, as well as cyclic constituents wherein the ring is completed through another portion of the molecule (that is, for example, any two indicated constituents may together form an alicyclic radical); (2) substituted hydrocarbon constituents, that is, those constituents containing non-hydrocarbon groups which, in the context of this invention, alter the predominantly hydrocarbon nature of the constituent to the extent of causing the end product to be water soluble; those skilled in the art will be aware of such groups (typically these include, but are not necessarily limited to: hydroxy, mercapto, nitroso, nitro, sulfoxy, and the like); and (3) hetero atom constituents, this is, constituents which will, while having a predominantly water soluble character within the context of this invention, contain an atom other than carbon present in a ring or chain otherwise composed of carbon atoms (typically, alkoxy, alkylthio and the like). Suitable hetero atoms will be apparent to those skilled in the art and typically include sulfur, oxygen, nitrogen and such constituents as, e.g., pyridyl, furyl, thienyl, imidazolyl, and the like.

Thus, the basic reaction:

CaCO₃+MgCO₃+4 HSO₃NH₂→Ca(SO₃NH₂)₂+Mg(SO₃NH₂)₂+2CO₂↑+2H₂O (Eq. 1)

when modified by the substitution of sulfamic acid by its derivative, becomes:

CaCO₃+MgCO₃+4 HSO₃N R⁴R⁵→Ca(SO₃N R⁴R⁵)₂+Mg(SO₃N R⁴R⁵)₂+2H₂CO₃

where:

2H₂CO₃→2CO₂↑+2H₂O (Eq. 2)

Amine Reactant for Producing More Complex Acid Derivatives

Optionally, more complex sulfamic acid derivatives may be produced by further reaction with an amine. The amine functionality typically includes but are not necessarily limited to: aromatic amines, alkanolamines, C₁₋₁₀ alkyl amines, or other amine derivatives. These amines may be primary, secondary, or tertiary. Also included are diamines, triamines, or other polyamines.

Typically, the amine starting material contains from one to about 10 carbon atoms. The amine may be primary, secondary or tertiary. Also, it may be aliphatic, alicyclic or aromatic. The amine preferably contains other groups, such as for example hydroxy, mercapto, nitroso, nitro, sulfoxy and the like. In particular, hydroxy-substituted amines, as for example ethanolamine (also known as monoethanolamine, MEA), are of interest as starting materials.

In order to insure a water-soluble reaction product, the starting amine will typically contain from one up to and including about seven carbon atoms. Whether the reaction product is water-soluble or oil soluble depends not only on the carbon chain length of the starting amine, but also to some extent on the presence of hydrophilic groups, and particular, hydroxy.

The amine starting material may be a monoamine, a diamine, a triamine, or higher polyamine. Typically, the starting material may contain from 1 to about 6 amino or substituted amino groups. Preferred starting amines are those containing 1 to about 3 amino or substituted amino groups. The term, “polyamine”, as used herein includes diamines and triamines as well as amines containing more than three amino or substituted amino groups. Monoamines are particularly preferred amine starting materials.

Amine starting materials used in this invention may be represented by the formula (II) below, as disclosed in U.S. Pat. No. 6,204,228, incorporated herein by reference in its entirety:

R¹(NR ²R³)ₙ (II)

where:

R¹ is a hydrocarbyl group having the valence n;

R² and R³ are independently selected from the group consisting of hydrogen and a monovalent hydrocarbyl group; and n is a small positive integer, i.e., from 1 to about 6.

The total number of carbon atoms in the reaction product may be from 1 to about 20 and preferably is from 1 to about 10.

Preferably:

R¹ is alkyl, hydroxyalkyl, cycloalkyl or aryl;

R² is hydrogen, alkyl, hydroxyalkyl, cycloalkyl or aryl;

R³ is hydrogen, and n is from 1 to 3.

More preferably:

R¹, R³, are as above defined; R² is hydrogen; and n=1.

Ethanolamine is a preferred starting material when a water-soluble reaction product is desired.

Reaction of the starting amine with sulfamic acid or sulfamic acid reactant is carried out in a liquid reaction medium. The starting amines for the most part (excluding those of higher molecular weight) are liquids at the desired reaction temperature, and in this case, the reaction may be carried out “neat” or in bulk, using the starting amine as the reaction medium. Alternatively, and in all cases when the starting amine is a solid, the reaction will be carried out in an organic solvent medium. Suitable solvents include, but are not necessarily limited to: ethanol, other lower monohydric alcohols, ethylene glycol, mineral spirits, and the like. The solvent (when one is used) should not react with either sulfamic acid or the starting amine under the reaction conditions used for reacting the amine with sulfamic acid.

Stoichiometric quantities of the starting amine and sulfamic acid react quantitative to produce the desired reaction product. The preferred reaction products are addition products, and in particular, are sulfamic acid salts of the respective starting amines. The preferred reaction products are liquids at room temperature (25° C.), although in some cases a solid reaction product may be desirable.

More Complex Sulfamic Acid Derivatives

The reaction product of this invention typically contains from 1 to about 7 carbon atoms, preferably from 2 to about 5 carbon atoms. Here again it must be noted that these products are merely exemplary of the broader genus of all water soluble sulfamic acid derivatives that are useful in the practice of the invention. In general, water soluble products contain from 1 to about 7 carbon atoms.

The reaction product may be either an addition product or a substitution product, i.e., a sulfonamide. Both will be described in greater detail below. Formation of an addition product is favored when the reaction temperature is from room temperature (20° C.) up to about 100° C. A preferred temperature range for obtaining an addition product is from about 80° to about 95° C. (i.e., about 200° F., range limits have been rounded since the limit is not sharply defined). Formation of a substitution product, i.e., a sulfonamide is favored at reaction temperatures from about 100° C. to about 200° C. (i.e., about 400° F.).

The preferred reaction products are addition products, and specifically, sulfamic acid salts of amines, which may be represented by the general formula (III) below, also as disclosed in U.S. Pat. No. 6,204,228, incorporated herein by reference in its entirety:

R¹(NR²R³)ₙ.nHSO₃NR⁴R⁵ (III)

in formula (III) above,

R¹ is selected from the group consisting of alkyl, hydroxyalkyl, cycloalkyl, and aryl,

R² is selected from the group consisting of hydrogen, alkyl, hydroxyalkyl, cycloalkyl and aryl;

R³, R⁴ and R⁵ are hydrogen;

and n is an integer from 1 to 3.

Reaction products of the formula (III) may be prepared by reaction of a starting amine of the formula (II) with a sulfamic acid compound of the formula (I) according to equation (1) below.

R¹(NR²R³)ₙ+nHSO₃NR⁴R⁵→R¹(NR²R³)ₙ.nHSO₃NR⁴R⁵⇄nHSO₃NR⁴R⁵.R¹(NR²R³)ₙ (Eq.3)

Thus, the basic reaction:

CaCO₃+MgCO₃+4 HSO₃NH₂→Ca(SO₃NH₂)₂+Mg(SO₃NH₂)₂+2H₂CO₃→Ca(SO₃NH₂)₂+Mg(SO₃NH₂)₂+2CO₂↑+2H₂O (Eq. 1)

when modified by the substitution of sulfamic acid by its more complex derivative, becomes:

nCaCO₃+nMgCO₃+R¹(NR²R³)ₙ.4nHSO₃NR⁴R⁵→R¹(NR²R³)₂ₙ.nCa(SO₃NR⁴R⁵)₂.nMg(SO₃NR⁴R⁵)₂+2n CO₂↑+2nH₂O (Eq.4)

where:

R¹(NR²R³)ₙ.nHSO₃NR⁴R⁵⇄R¹(NR²R³)ₙ+nH(SO₃NR⁴R⁵)+nCa²⁺[CO₃]²⁻+nMg²⁺[CO₃]²⁻+4n[H⁺[SO₃NR⁴R⁵]⁻]→nCa²⁺(SO₃NR⁴R⁵)₂+nMg²⁺(SO₃NR⁴R⁵)₂+2nCO₂↑+2nH₂O

nCaCO₃+nMgCO₃+R¹(NR²R³)ₙ.4nHSO₃NR⁴R⁵→R¹(NR²R³)ₙ.nCa(SO₃NR⁴R⁵)₂.nMg(SO₃NR⁴R⁵)₂+2nCO₂↑+2nH₂O

As noted above, the reaction proceeds as a simple substitution. The relative proportions of Calcium carbonate to Magnesium carbonate may be varied without upsetting the stoichiometric balance of the equation. Thus, through the addition of limestone or Magnesite to the Dolomite reactant, its proportions may be varied to render all respective quantitative proportions of Calcium sulfamate to Magnesium sulfamate, e.g., an all Calcium sulfamate product; or, an all Magnesium sulfamate product; or, a product containing any relative proportion of Calcium sulfamate to Magnesium sulfamate therebetween.

In a preferred embodiment of the present invention, the composition is water soluble, the amine/sulfamic acid compound reaction product is water soluble, and the amine reactant of formula (II) contains from 1 to about 7 carbon atoms and R⁴ and R⁵ are hydrogen. More preferably in this embodiment, in the amine of formula (II), R¹ is hydroxyalkyl and R², R³ are hydrogen, and n=1. It should be noted here that although water soluble amines are preferred, any oil soluble amine that reacts to produce a water solution stable sulfamate salt product is also useful as a reactant.

Mixture of Dolomite With Other Carbonates and/or Hydroxides and/or Carbonate-Hydroxides and/or Carbonate-Hydroxides-Oxides and/or Substantially Pure Powdered Metals

It must again be noted that the invention broadly contemplates the reaction of sulfamic acid and/or any of its water soluble derivatives and/or combinations thereof with any substantially pure powdered metal, including but not limited to: Powdered Zinc, Powered Iron, Powdered Manganese, Powdered Copper, Powdered Molybdenum, Powdered Nickel, Powdered Magnesium, Powdered Cobalt (e.g., any powdered metal which forms a micronutrient and/or macronutrient) and combinations thereof, and/or Carbonate and/or Hydroxide and/or Carbonate Hydroxide and/or any Hydroxide Oxide and/or any combinations thereof that contain macronutrient and/or micronutrient moieties and provide a water solution stable salt. However, as merely exemplary and as noted above, formulation of the composition to accommodate deficiencies of a specific soil sample can typically be done by the addition of predetermined proportions of various micronutrient/macronutrient substantially pure powdered metal, Carbonates and/or Carbonate Hydroxides and/or Hydroxides and/or Hydroxide Oxides and/or combinations thereof, to the Dolomite of the basic reaction. These may be selected from naturally occurring ores. Exemplary of such ores, but not necessarily limiting to the invention, are: Aragonite (Calcium Carbonate), Artinite (Hydrated Magnesium Carbonate Hydroxide), Aurichalcite (Zinc Copper Carbonate Hydroxide), Azurite (Copper Carbonate Hydroxide), Barringtonite (Hydrated Magnesium Carbonate), Baylissite (Hydrated Potassium Magnesium Carbonate), Brugnatellite (Hydrated Magnesium Iron Carbonate Hydroxide), Butschliite (Potassium Calcium Carbonate), Calcite (Calcium Carbonate), Gaspeite (Nickel Magnesium Iron Carbonate), Magnesite (Magnesium Carbonate), Rhodochrosite (Manganese Carbonate), Siderite (Iron Carbonate), Smithsonite (Zinc Carbonate), Ankerite (Calcium Iron Carbonate), Huntite (Calcium Magnesium Carbonate), Kutnohorite (Calcium Manganese Magnesium Iron Carbonate), Minrecordite (Calcium Zinc Carbonate), Norsethite (Barium Magnesium Carbonate), Fairchildite (Potassium Calcium Carbonate), Georgeite (Hydrated Copper Carbonate Hydroxide), Hellyerite (Hydrated Nickel Carbonate), Hydrozincite (Zinc Carbonate Hydroxide), Ikaite (Hydrated Calcium Carbonate), Kalicinite (Potassium Bicarbonate), Lansfordite (Hydrated Magnesium Carbonate), Loseyite (Manganese Zinc Carbonate Hydroxide), Malachite (Copper Carbonate Hydroxide), Monohydrocalcite (Hydrated Calcium Carbonate), Nesquehonite (Hydrated Magnesium Bicarbonate Hydroxide), Pokrovskite (Hydrated Magnesium Carbonate Hydroxide), Pyroaurite (Hydrated Magnesium Iron Carbonate Hydroxide), Glaukospherite (Copper Nickel Carbonate Hydroxide), Mcguinnessite (Magnesium Copper Carbonate Hydroxide), Nullaginite (Nickel Carbonate Hydroxide), Rosasite (Copper Zinc Carbonate Hydroxide), Zincrosasite (Zinc Copper Carbonate Hydroxide), Sclarite (Zinc Magnesium Manganese Carbonate Hydroxide), Sergeevite (Hydrated Calcium Magnesium Carbonate Bicarbonate Hydroxide), Sjogrenite (Hydrated Magnesium Iron Carbonate Hydroxide), Teschemacherite (Ammonia Bicarbonate), Vaterite (Calcium Carbonate), Zaratite (Hydrated Nickel Carbonate Hydroxide) and any combination thereof. These compounds are preferred with cost is a factor and large amounts of them are to be added to the Dolomite reactant. As previously noted, the foregoing list is exemplary, and by no means is meant to limit the scope of the invention.

However, where cost is not a factor, e.g., addition of small amounts of micronutrients, other more refined materials that are suitable for the practice of the invention, include but are not necessarily limited to: Tetra-n-butylphosphonium hydroxide, Tetra-n-butylammonium hydroxide, Tetramethylammonium hydroxide, Tetraethylammonium hydroxide, Iron (III) oxyhydroxide, Iron (III) hydroxide (gamma), Iron (III) hydroxide (alpha), Potassium hydroxide, Nickel (II) hydroxide, Hexane-1,6 bis (tributylammonium) dihydroxide, Calcium hydroxide, Tetra-n-propylammonium hydroxide, Tetra-n-butylphosphonium hydroxide, Tetra-n-butylammonium hydroxide, Cobalt (II) hydroxide, Copper (II) carbonate dihydroxide, Copper (II) carbonate (basic), Copper (II) hydroxide, Ammonium hydroxide, Magnesium carbonate hydroxide, Methylboron dihydroxide, Magnesium hydroxide, Molybdenum hydroxide oxide phosphate, Calcium phosphate hydroxide, Calcium phosphate tribasic, Calcium hydroxide, Zinc subcarbonate, Zinc carbonate (basic), Zinc carbonate hydroxide, Zinc hydroxide, Potassium bicarbonate, Potassium hydrogen carbonate, Potassium carbonate, Nickel (II) carbonate, Nickel (II) carbonate hydroxide, Nickel (II) carbonate (anhydrous), Nickel (II) carbonate (basic), Manganese (II) carbonate, Magnesium carbonate (basic), Magnesium carbonate hydroxide, Ammonium bicarbonate, Ammonium hydrogen carbonate, Ammonium carbonate, Nickel (II) hydroxide, Calcium phosphate hydroxide, Calcium phosphate tribasic, limestone, Magnesite, lime, slaked lime, magnesium oxide, and/or any combination thereof.

The foregoing list is exemplary, and by no means is meant to limit the scope of the invention. The invention may be further understood through the following examples:

Use as a Fertilizer

### EXAMPLE 1

A soil sample was analyzed, and found to be deficient in the macronutrients Calcium, Sulfur and Magnesium as well as the micronutrient manganese. A reaction batch was prepared by admixing 100 grams of Calcium carbonate, 84 grams of Magnesium carbonate, and 2 grams of Manganese carbonate to 390 grams of Sulfamic acid. The mixture was reacted and recovered as an aqueous solution. The reaction proceeded vigorously at first and was permitted to continue to equilibrium, e.g., until no further evolution of gaseous CO₂ was observed. The mixture was recovered as an aqueous solution. The solution was then applied to the plot of land from which the sample was taken to adjust Calcium, Sulfur, Magnesium and Manganese to their recommended concentrations.

The substantially pure Carbon dioxide which was released during the reaction was captured, filtered, compressed, and marketed. Plants on the plot of land were observed until signs of deficiency substantially disappeared.

### EXAMPLE 2

A soil sample was analyzed, and found to be deficient in the macronutrient potassium as well as the micronutrient manganese. A reaction batch was prepared by admixing 100 grams of Calcium carbonate, 84 grams of Magnesium carbonate, and 216 grams of Potassium carbonate to 1136 grams of Sulfamic acid. The mixture was reacted and recovered as an aqueous solution. The reaction proceeded vigorously at first and was permitted to continue to equilibrium, e.g., until no further evolution of gaseous CO₂ was observed. The solution was them applied to the plot of land from which the sample was taken. Plants on the plot of land were observed until signs of potassium and manganese deficiencies substantially disappeared. Another sample was later taken to further adjust Potassium and Manganese to their recommended concentrations.

### EXAMPLE 3

The present invention was practiced to mix a plant nutrient composition to grow a crop of tomatoes hydroponically. A reaction batch of stock solution sufficient to make 4,000 liters of dilute hydroponic plant nutrient was prepared by admixing 207 grams of Dolomite with 437 grams of Sulfamic acid in 10 liters of water. The mixture was reacted and recovered as an aqueous solution. The reaction proceeded vigorously at first and was permitted to continue to equilibrium, e.g., until no further evolution of gaseous CO₂ was observed. To that was added: 504 g of Ca(NO₃)₂, 348 g of Mg(NO₃)₂, 2.5 Kg of KNO₃, 1 Kg KH₂PO₄, 9.5 mg of CoCL₂, 788 mg of Cu-EDTA, 9.2 g of Fe-ETPA, 17 mg of (NH₄)₆Mo₇O₂₄, 1.1 g of H₃BO₃, 1.2 g Mn-EDTA, 144 mg NH₄Cl, 1.5 g of Zn-EDTA. The stock solution was diluted to a final volume of 4,000 liters and applied to a crop of tomatoes growing in an apparatus designed for commercial hydroponic production by means of Nutrient Flow Technique (“NFT”) wherein the tomatoes' roots are grown inside a trough through which the dilute hydroponic plant nutrient composition is continually recirculated.

### EXAMPLE 4

The present invention has been practiced so that agronomists using a dedicated computer software program running on a standard PC, or on the Internet, have rapidly and economically formulated a multitude of plant nutrient compositions. The software program calculates one of an infinite number of plant nutrient compositions by combining one or more commercially prepared concentrated plant nutrient stock solutions, which were manufactured by practicing the instant invention, with a small number of single chemical compounds known to agronomists as “simples,” i.e. mainly Urea and salts of Nitric acid and Phosphoric acid such as Ca(NO₃)₂ and KH₂PO₄. The computer software program also uses a database containing metrics listing the nutrient components in the guaranteed analysis of a multitude of commercially available fertilizer mixtures manufactured by a multitude of fertilizer manufacturers. The computer software program is especially useful to agronomists for mixing highly complex plant nutrient compositions containing up to all 16 essential nutrients in a solution stable state. This reduces or eliminates the need for agronomists to stock a larger number of specialty fertilizer formulas. Instead, any desired formula can be rapidly formulated and mixed from a small number of raw materials. Typically, an infinite number of formulations can be mixed using no more than nine components.

To mix concentrated plant nutrient compositions using the computer software program, typically two commercially prepared concentrated stock solutions are prepared according to the practice taught by the instant invention.

Solution #1, Calcium Magnesium Sulfur Stock Solution

A reaction batch sufficient to make 1,000 liters of concentrated calcium magnesium sulfur stock solution was prepared by admixing 138.2 Kg of Dolomite with 291 Kg of Sulfamic acid in 600 liters of water. The mixture was reacted and recovered as an aqueous solution. The reaction proceeded vigorously at first and was permitted to continue to equilibrium, e.g., until no further evolution of gaseous CO₂ was observed. Then 25 Kg of Ca(NO₃)₂ and 201 Kg of Mg(NO₃)₂ were dissolved in the reaction mixture and the total volume was increased to 1,000 liters.

Solution #2, Trace Mineral Solution

A reaction batch sufficient to make 100 liters of concentrated trace mineral stock solution was prepared by admixing 256 g of powdered Cu metal, 266 g of powdered Mn metal, and 387 g of powdered zinc metal with 3.7 Kg of Sulfamic acid in 60 liters of water. The mixture was reacted and recovered as an aqueous solution. The reaction proceeded vigorously at first and was permitted to continue to equilibrium, e.g., until no further evolution of gaseous CO₂ was observed. Then 12.7 g of CoCl₂ and 12.3 Kg of Fe-EDTA, 22.7 g of (NH₄)₆Mo₇O₂₄, 1.4 Kg of H₃BO₃, 8 g of Ni(NO₃)₂, and 192 g of NH₄Cl were dissolved in the reaction mixture and the total volume was increased to 100 liters.

Using the computer software program, and the pre-mixed commercially available stock solutions, an agronomist quickly calculated a plant nutrient composition sufficient to make 1,000 gallons of dilute plant nutrient solution to feed a crop of orchids growing in tree bark by admixing: 500 ml of Solution #1, 125 ml of Solution #2, 787 g of NH₄NO₃, 469 g of Ca(NO₃)₂, 576 g of KNO₃, and 400 g of NH₄H₂PO₄ in such a manner that the final solution volume equaled 1,000 gallons.

### EXAMPLE 5

The present invention may be practiced through the use a computerized robotic automation system to rapidly formulate and mix a multitude of concentrated plant nutrient compositions, i.e. “Fertilizer-On-Demand.” The computerized automation system is especially useful to fertilizer manufacturers for mixing highly complex plant nutrient compositions containing up to all 16 essential nutrients in a solution stable state, in concentrations sufficient to satisfy the labeling claim requirements imposed by USDA and state regulations for inclusion under the Guaranteed Analysis of the label. Pursuant to such regulations, each nutrient claimed must be present in a prescribed minimum concentration or greater to be listed on the label, e.g., the allowable concentration of the combined macronutrients Nitrogen, Phosphorus and Potassium must be ≧5% of the total mass; concentrations of each Calcium and Sulfur must be ≧1% of the total mass, and the concentration of Magnesium must be ≧0.5% of the total mass. Similar requirements are also imposed for each of the essential trace nutrients.

To accurately calculate the formulation of, and automate the mixing of complex concentrated plant nutrient compositions, a computer running a dedicated telemetry and control program, equipped with an analog to digital converter and input/output board was connected to a fluid circuit of solenoids and chemical metering pumps. This apparatus was used to semi-automatically mix one of an infinite range of fertilizer compositions. The computer was programmed to combine moieties of various plant nutrient compounds stored in holding tanks containing concentrated stock solutions of macronutrients and micronutrients. One of an infinite number of custom fertilizer compositions was rapidly formulated and mixed in one of an infinite number of output quantities to accommodate an agronomist's individual requirements.

In order to prepare a stock solution required to practice computer-controlled automated mixing of the complex concentrated plant nutrient compositions, a reaction batch was prepared by admixing 88.9 Kg of 95% pure Dolomite and 184.4 Kg of Sulfamic acid. The mixture was reacted and recovered as an aqueous solution, and thereafter stored in a 400 liter holding tank. The mixture contained the following nutrients: 8.94 Kg of Ca, 11.48 Kg of Mg, 60.96 Kg of S, and 26.59 Kg of N. Additional individual concentrated stock solutions were also prepared by dissolving commercially available preparations of NH₄NO₃, KNO₃, Ca(NO₃)₂, Mg(NO₃)₂, H₃PO₄, H₃BO₃, CoCO₃, H₃Mo₃, NH₄Cl, NaNO₃, Fe-ETPA, Cu-EDTA, Mn-EDTA, Zn-EDTA, and Ni(NO₃)₂. Each additional concentrated stock solution was stored in a designated holding tank of appropriate size. Some of these, such as KNO₃, were heated to maintain a solution temperature ≧60° C. (140° F.) to avoid crystallization in saturated solutions containing endothermic solutes. These stock solutions were later admixed in predetermined respective proportions so as to provide one of an infinite number of fertilizer compositions to accommodate the deficiencies of a sample of a specific body of soil.

Use as a Cell Culture Medium

### EXAMPLE 6

The invention was practiced to create a fermentation medium for the production of commercial quantities of extracellular Staphylococcal Protein A. Extracellular Staphylococcal Protein A is a biomedically important membrane protein that binds most types of human antibodies. To accomplish this, a culture media having the capacity to support the growth of the bacterial cell Staphylococcus aureus (S. aureus) was formulated. A concentrated stock solution was prepared as follows: 3 liters of deionized water and 1,289 grams sulfamic acid were admixed and dissolved in a 4 liter Erlenmeyer flask. The following was then added and dissolved therein: 150.5 grams finely powdered 95% pure Dolomite, 271 grams Potassium carbonate, 0.9 grams substantially pure powdered copper metal, 1.67 grams Manganese carbonate, and 0.96 grams substantial pure powdered zinc metal.

The reaction proceeded vigorously at first and was permitted to continue to equilibrium, e.g., until no further evolution of gaseous CO₂ was observed. The reaction solution was then centrifuged and filtered to 0.2 μM to remove any insoluble components. 22.8 grams Monopotassium phosphate and 34.0 grams Dipotassium phosphate was thereafter dissolved in the mixture to buffer the media solution to a pH range near neutral. Thereafter, 15.0 grams Iron-ETPA (Diethylenetriaminepentaacetic acid) was dissolved in the mixture, and enough deionized water was added to increase the solution to a final volume of 4 liters. The concentrated stock solution was then stored without refrigeration until needed.

When needed, the stock solution was supplemented by adding appropriate amounts of glucose, peptone, and brewer's yeast sufficient to provide the nutrients required to make 800 liters of Staphylococcal fermentation media.

### EXAMPLE 7

The invention was practiced to create a mammalian cell culture medium that permits growth of hepatocytes in vitro without human or fetal bovine serum. One (1) liter of mineral salt solution was prepared for use as a base for the cell culture medium stock solution, by the following reaction: 600 ml deionized water and 644 mg Sulfamic acid were admixed in a 1 liter Erlenmeyer flask. After the foregoing was dissolved: 181 mg Calcium carbonate, 86 mg Magnesium carbonate, 190 μg Manganese carbonate, 1.42 mg Zinc carbonate, and 530 μg Copper carbonate were then added.

The reaction proceeded vigorously at first and was thereafter permitted to continue to equilibrium, e.g., until no further evolution of gaseous CO₂ was noticed. The reaction solution was then centrifuged and filtered to 0.2 μM to remove any insoluble components. 200 mg Potassium chloride, 6.4 g Sodium chloride, 3.7 g Sodium hydrogen carbonate, 125 mg Monosodium phosphate, 100 μg Ferric nitrate, 28 μg Selenic acid, 63 mg L-cystine hydrochloride, 30 mg glycine, 44 mg L-histidine, 101 mg L-isoleucine, 101 mg L-leucine, 146 mg L-lysine, 30 mg L-methionine, 66 mg L-phenylalanine, 42 mg L-serine, 92 L-threonine, 16 mg L-tryptophan, 104 mg L-tyrosine, 94 mg L-valine, 4 mg choline chloride, 4 mg folic acid, 6 mg i-inositol, 175 mg pyridoxine, 186 mg pyridoxal, 40 mg riboflavin, 4 mg thiamine, 1.6 g D-galactose, 3.3 g D-glucose, 86 mg nicotinamide, 16 mg L-proline, 26 mg L-arginine, 112 mg L-omithine, 34 mg transferrin, and 3.1 mg L-glutamine were then dissolved in this solution. The mixture was thereafter stirred until clear. Deionized water was then add to reach a final solution volume of 1 liter. The final solution was sterilized by filtration at 0.2 μM and stored at −80° C. until needed for future use.

### EXAMPLE 8

The instant invention was practiced to prepare a concentrated nutrient stock solution. The concentrated nutrient stock solution was used for mixing 100 liters of dilute establishment stage plant cell culture media that supports meristem cloning of chrysanthemums in vitro. One (1) liter of the concentrated stock solution was prepared so as to provide a base for the plant cell culture medium, by the following reaction: 600 ml deionized water, 129.3 g HSO₃NH₂ were admixed in a 1 liter Erlenmeyer flask. After the foregoing dissolved: 39.7 g of CaCO₃, 12.7 g of MgCO₃, 9.82 mg of Cu metal, 429 mg Mn metal, and 829 mg Zinc metal were added. The mixture was reacted and recovered as an aqueous solution. The reaction proceeded vigorously at first and was thereafter permitted to continue to equilibrium, e.g., until no further evolution of gaseous CO₂ was observed. It was then centrifuged and filtered to 0.45 μM to remove insoluble components. 190 g KNO₃, 165 g NH₄NO₃, 2.5 mg of CoCl₂.6H₂O, 83 mg of KI, 620 mg of H₃BO₃, and 17 g of KH₂PO₄, NaMoO₄.2H₂O was then dissolved in the mixture. The mixture volume was thereafter increased to 1 liter with deionized water and stored at room temperature until needed.

Definitions

The term “plant promoting” as used herein refers to the capacity of a material to provide a benefit to plants in a body of soil. In regard to a composition for treating plants in a body of soil, such benefit may include, but is not necessarily limited to providing: improved plant growth response; improved uptake of micronutrients and/or macronutrients by plants; improved drought resistance; improved soil structure in a body of soil; improved nitrate conversion to proteins and amino acids; improve cell wall stabilization and extension; improved secretory processes; improved membrane stabilization; improved cation/anion balance and osmo-regulation; improved chlorophyll and protein synthesis; improved enzyme activation, phosphorylation and photosynthesis; and, improved carbohydrate portioning.

The term “cell” as used herein, refers to any living cell including but not limited to: to any animal cell, including but not limited to: any mammalian, insect, and/or any plant cell including but not limited to: bacterial cell; any yeast or fungal cell; and/or any cell having plant characteristics and/or any cell having animal characteristics and/or any cell having both plant and animal characteristics.

The term “cell promoting” as used herein refers to the capacity of a material to provide a benefit to an individual cell or body of cells in a cell culture or tissue engineering medium. In regard to a composition for treating cells in a culture medium, such benefit may include, but is not necessarily limited to providing: improved cell growth response; improved uptake of micronutrients by cells; improved nitrate conversion to proteins and amino acids; improved cell wall stabilization and extension; improved secretory processes; improved membrane stabilization; improved cation/anion balance and osmo-regulation; improved chlorophyll production (in the case of plant cells); improved protein synthesis; improved enzyme activation, phosphorylation and photosynthesis (in the case of plant cells); and, improved carbohydrate portioning.

The term “solution stable” as used herein means at least: the capacity of a cell promoting effective amount of a compound to be placed into, and remain in solution when dissolved in a liquid such as water for a substantial period of time typically characterized as the “shelf-life.” The term “shelf-life” is used herein with its substantially same meaning as defined by the prior art.

The term “substituted” refers to that condition wherein one or more of the hydrogen atoms affixed to an amine moiety has been replaced with some other chemical moiety, e.g., (—OH, —COOH, —COOR, and the like).

The term “compensating amount” as used herein, refers to that quantitative percentage of a micronutrient and/or macronutrient in a soil treatment composition by which the quantitive percentage of that micronutrient and/or macronutrient may be restored to, or maintained within, plant acceptable limits within a body of soil after its treatment with the soil treatment composition.

The term “soil sample” as used herein, refers to a sample of soil having a composition, including macronutrients and micronutrients that is characteristic of a substantially large body of soil.

The term “typically” as used herein refers to a species which is merely exemplary of a broader genus.

The terms “sulfamic acid compound” or “sulfamic acid reactant” as used herein, refer to Sulfamic acid, and/or any water soluble or oil soluble derivative of Sulfamic acid and/or any combination thereof, that reacts with any other material as exemplified by those compounds disclosed above, to produce a water solution stable salt product. The term “any other material” as used in the foregoing sentence, refers to any material or combination of materials including but not limited to those compounds disclosed above, that react with a sulfamic acid compound or a sulfamic acid reactant, to produce a water solution stable salt product.

Although the invention has been described with reference to certain preferred embodiments, it will be appreciated that many variations and modifications may be made within the scope of the broad principles of the invention. Hence, it is intended that the preferred embodiments and all of such variations and modifications be included within the scope and spirit of the invention, as defined by the following claims.

I claim:

1. A composition for treating plants in a body of soil, comprising:
substantially any combination of water solution stable macronutrients and/or micronutrients of substantially any concentration and/or concentrations.

2. The composition of claim 1, further comprising:
a plant promoting effective amount of solution stable Ca⁺⁺ moieties;
a plant promoting effective amount of solution stable S⁶⁺ moieties;
a plant promoting effective amount of solution stable Mg⁺⁺ moieties; and,
a plant promoting effective amount of solution stable N³⁻ moieties.

3. The composition of claim 2, wherein said solution stable moieties are a reaction product formed from the reaction of:
a first reactant selected from the group consisting of Sulfamic acid, a water soluble Sulfamic acid derivative, an oil soluble Sulfamic acid derivative that can be reacted to provide a water solution stable Sulfamate, and combinations thereof; and,
a second micronutrient and/or macronutrient moiety-including reactant selected from the group consisting of a carbonate, a hydroxide, a carbonate hydroxide, a hydroxide oxide, a metal, and combinations thereof.

4. The composition of claim 2, wherein the solution stable moieties are formed by reacting effective amounts of:
at least one member selected from the group consisting of:
a powdered micronutrient metal, a powdered macronutrient metal, Dolomite, Aragonite (Calcium Carbonate), Artinite (Hydrated Magnesium Carbonate Hydroxide), Aurichalcite (Zinc Copper Carbonate Hydroxide), Azurite (Copper Carbonate Hydroxide), Barringtonite (Hydrated Magnesium Carbonate), Baylissite (Hydrated Potassium Magnesium Carbonate), Brugnatellite (Hydrated Magnesium Iron Carbonate Hydroxide), Butschliite (Potassium Calcium Carbonate), Calcite (Calcium Carbonate), Gaspeite (Nickel Magnesium Iron Carbonate), Magnesite (Magnesium Carbonate), Rhodochrosite (Manganese Carbonate), Siderite (Iron Carbonate), Smithsonite (Zinc Carbonate), Ankerite (Calcium Iron Carbonate), Huntite (Calcium Magnesium Carbonate), Kutnohorite (Calcium Manganese Magnesium Iron Carbonate), Minrecordite (Calcium Zinc Carbonate), Norsethite (Barium Magnesium Carbonate), Fairchildite (Potassium Calcium Carbonate), Georgeite (Hydrated Copper Carbonate Hydroxide), Hellyerite (Hydrated Nickel Carbonate), Hydrozincite (Zinc Carbonate Hydroxide), Ikaite (Hydrated Calcium Carbonate), Kalicinite (Potassium Bicarbonate), Lansfordite (Hydrated Magnesium Carbonate), Loseyite (Manganese Zinc Carbonate Hydroxide), Malachite (Copper Carbonate Hydroxide), Monohydrocalcite (Hydrated Calcium Carbonate), Nesquehonite (Hydrated Magnesium Bicarbonate Hydroxide), Pokrovskite (Hydrated Magnesium Carbonate Hydroxide), Pyroaurite (Hydrated Magnesium Iron Carbonate Hydroxide), Glaukospherite (Copper Nickel Carbonate Hydroxide), Mcguinnessite (Magnesium Copper Carbonate Hydroxide), Nullaginite (Nickel Carbonate Hydroxide), Rosasite (Copper Zinc Carbonate Hydroxide), Zincrosasite (Zinc Copper Carbonate Hydroxide), Sclarite (Zinc Magnesium Manganese Carbonate Hydroxide), Sergeevite (Hydrated Calcium Magnesium Carbonate Bicarbonate Hydroxide), Sjogrenite (Hydrated Magnesium Iron Carbonate Hydroxide), Teschemacherite (Ammonia Bicarbonate), Vaterite (Calcium Carbonate), Zaratite (Hydrated Nickel Carbonate Hydroxide), Tetra-n-butylphosphonium hydroxide, Tetra-n-butylammonium hydroxide, Tetramethylammonium hydroxide, Tetraethylammonium hydroxide, Iron (III) oxyhydroxide, Iron (III) hydroxide (gamma), Iron (III) hydroxide (alpha), Potassium hydroxide, Nickel (II) hydroxide, Hexane-1,6-bis (tributylammonium) dihydroxide, Calcium hydroxide, Tetra-n-propylammonium hydroxide, Tetra-n-butylphosphonium hydroxide, Tetra-n-butylammonium hydroxide, Cobalt (II) hydroxide, Copper (II) carbonate dihydroxide, Copper (II) carbonate (basic), Copper (II) hydroxide, Ammonium hydroxide, Magnesium carbonate hydroxide, Methylboron dihydroxide, Magnesium hydroxide, Molybdenum hydroxide oxide phosphate Calcium phosphate hydroxide, Calcium phosphate tribasic, Calcium hydroxide, Zinc subcarbonate, Zinc carbonate (basic), Zinc carbonate hydroxide, Zinc hydroxide, Potassium bicarbonate, Potassium hydrogen carbonate, Potassium carbonate, Nickel (II) carbonate, Nickel (II) carbonate hydroxide, Nickel (II) carbonate (anhydrous), Nickel (II) carbonate (basic), Manganese (II) carbonate, Magnesium carbonate (basic), Magnesium carbonate hydroxide, Ammonium bicarbonate, Ammonium hydrogen carbonate, Ammonium carbonate, Nickel (II) hydroxide, Calcium phosphate hydroxide, Calcium phosphate tribasic, limestone, Magnesite, lime, slaked lime, magnesium oxide, and/or any combination thereof; and,
at least one sulfamic compound, selected from the group consisting of a compound of the formula (II):
HSO₃NR⁴R⁵ (II)
wherein:
R⁴ and R⁵ are independently selected from the group consisting of hydrogen and a monovalent hydrocarbyl group containing from 1 to about 10 carbon atoms; and at least one of R⁴ or R⁵ is hydrogen;
a compound of the formula (III):
R¹(NR²R³)ₙ.nHSO₃NR⁴R⁵ (III)
wherein:
R¹ is selected from the group consisting of alkyl, hydroxyalkyl, cycloalkyl, and aryl,
R² is selected from the group consisting of hydrogen, alkyl, hydroxyalkyl, cycloalkyl and aryl; R³, R⁴ and R⁵ are hydrogen; and n is an integer from 1 to 3; and,
combinations thereof.

5. The composition according to claim 1, further comprising a plant promoting effective amount of water.

6. A substantially pure CO₂ product formed by the reaction process of claim 2.

7. A composition for restoring the concentration of at least one essential micronutrient or macronutrient to desirable levels in a body of soil, comprising:
substantially any combination of water solution stable macronutrients and/or micronutrients of substantially any concentration and/or concentrations.

8. The composition of claim 7, further comprising:
a plant promoting effective amount of solution stable Ca⁺⁺ moieties;
a plant promoting effective amount of solution stable S⁶⁺ moieties;
a plant promoting effective amount of solution stable Mg⁺⁺ moieties; and,
a plant promoting effective amount of solution stable N³⁻ moieties.

9. The composition of claim 8, wherein said solution stable moieties are a reaction product formed from the reaction of:
a first reactant selected from the group consisting of Sulfamic acid, a water soluble Sulfamic acid derivative, an oil soluble Sulfamic acid derivative that can be reacted to provide a water solution stable Sulfamate, and combinations thereof; and
a second micronutrient and/or macronutrient moiety-including reactant selected from the group consisting of a carbonate, a hydroxide, a carbonate hydroxide, a hydroxide oxide, a metal, and combinations thereof.

10. The composition of claim 8 further comprising:
a compensating amount of said micronutrient or macronutrient included in a solution stable compound formed by the reaction of effective amounts of:
at least one member selected from the group consisting of:
Dolomite, a powdered micronutrient metal, a powdered macronutrient metal, Aragonite (Calcium Carbonate), Artinite (Hydrated Magnesium Carbonate Hydroxide), Aurichalcite (Zinc Copper Carbonate Hydroxide), Azurite (Copper Carbonate Hydroxide), Barringtonite (Hydrated Magnesium Carbonate), Baylissite (Hydrated Potassium Magnesium Carbonate), Brugnatellite (Hydrated Magnesium Iron Carbonate Hydroxide), Butschliite (Potassium Calcium Carbonate), Calcite (Calcium Carbonate), Gaspeite (Nickel Magnesium Iron Carbonate), Magnesite (Magnesium Carbonate), Rhodochrosite (Manganese Carbonate), Siderite (Iron Carbonate), Smithsonite (Zinc Carbonate), Ankerite (Calcium Iron Carbonate), Huntite (Calcium Magnesium Carbonate), Kutnohorite (Calcium Manganese Magnesium Iron Carbonate), Minrecordite (Calcium Zinc Carbonate), Norsethite (Barium Magnesium Carbonate), Fairchildite (Potassium Calcium Carbonate), Georgeite (Hydrated Copper Carbonate Hydroxide), Hellyerite (Hydrated Nickel Carbonate), Hydrozincite (Zinc Carbonate Hydroxide), Ikaite (Hydrated Calcium Carbonate), Kalicinite (Potassium Bicarbonate), Lansfordite (Hydrated Magnesium Carbonate), Loseyite (Manganese Zinc Carbonate Hydroxide), Malachite (Copper Carbonate Hydroxide), Monohydrocalcite (Hydrated Calcium Carbonate), Nesquehonite (Hydrated Magnesium Bicarbonate Hydroxide), Pokrovskite (Hydrated Magnesium Carbonate Hydroxide), Pyroaurite (Hydrated Magnesium Iron Carbonate Hydroxide), Glaukospherite (Copper Nickel Carbonate Hydroxide), Mcguinnessite (Magnesium Copper Carbonate Hydroxide), Nullaginite (Nickel Carbonate Hydroxide), Rosasite (Copper Zinc Carbonate Hydroxide), Zincrosasite (Zinc Copper Carbonate Hydroxide), Sclarite (Zinc Magnesium Manganese Carbonate Hydroxide), Sergeevite (Hydrated Calcium Magnesium Carbonate Bicarbonate Hydroxide), Sjogrenite (Hydrated Magnesium Iron Carbonate Hydroxide), Teschemacherite (Ammonia Bicarbonate), Vaterite (Calcium Carbonate), Zaratite (Hydrated Nickel Carbonate Hydroxide), Tetra-n-butylphosphonium hydroxide, Tetra-n-butylammonium hydroxide, Tetramethylammonium hydroxide, Tetraethylammonium hydroxide, Iron (III) oxyhydroxide, Iron (III) hydroxide (gamma), Iron (III) hydroxide (alpha), Potassium hydroxide, Nickel (II) hydroxide, Hexane-1,6-bis(tributylammonium) dihydroxide, Calcium hydroxide, Tetra-n-propylammonium hydroxide, Tetra-n-butylphosphonium hydroxide, Tetra-n-butylammonium hydroxide, Cobalt (II) hydroxide, Copper (II) carbonate dihydroxide, Copper (II) carbonate (basic), Copper (II) hydroxide, Ammonium hydroxide, Magnesium carbonate hydroxide, Methylboron dihydroxide, Magnesium hydroxide, Molybdenum hydroxide oxide phosphate Calcium phosphate hydroxide, Calcium phosphate tribasic, Calcium hydroxide, Zinc subcarbonate, Zinc carbonate (basic), Zinc carbonate hydroxide, Zinc hydroxide, Potassium bicarbonate, Potassium hydrogen carbonate, Potassium carbonate, Nickel (II) carbonate, Nickel (II) carbonate hydroxide, Nickel (II) carbonate (anhydrous), Nickel (II) carbonate (basic), Manganese (II) carbonate, Magnesium carbonate (basic), Magnesium carbonate hydroxide, Ammonium bicarbonate, Ammonium hydrogen carbonate, Ammonium carbonate, Nickel (II) hydroxide, Calcium phosphate hydroxide, Calcium phosphate tribasic, limestone, Magnesite, lime, slaked lime, magnesium oxide, and/or any combination thereof; and,
at least one sulfamic compound selected from the group consisting of:
a compound of the formula (II):
HSO₃NR⁴R⁵ (II)
wherein:
R⁴ and R⁵ are independently selected from the group consisting of hydrogen and a monovalent hydrocarbyl group containing from 1 to about 10 carbon atoms; and at least one of R⁴ or R⁵ is hydrogen;
a compound of the formula (III):
R¹(NR²R³)ₙ.nHSO₃NR⁴R⁵ (III)
wherein:
R¹ is selected from the group consisting of alkyl, hydroxyalkyl, cycloalkyl, and aryl,
R² is selected from the group consisting of hydrogen, alkyl, hydroxyalkyl, cycloalkyl and aryl; R³, R⁴ and R⁵ are hydrogen; and, n is an integer from 1 to 3; and,
combinations thereof.

11. The composition according to claim 7, wherein said reaction product is water-soluble.

12. The composition according to claim 7, further comprising a plant promoting effective amount of water.

13. A substantially pure CO₂ product formed by the reaction process of claim 7.

14. A composition for treating living cells, comprising:
substantially any combination of water solution stable macronutrients and/or micronutrients of substantially any concentration and/or concentrations.

15. The composition of claim 14, further comprising:
a cell promoting effective amount of solution stable Ca⁺⁺ moieties;
a cell promoting effective amount of solution stable S⁶⁺ moieties;
a cell promoting effective amount of solution stable Mg⁺⁺ moieties; and,
a cell promoting effective amount of solution stable N³⁻ moieties.

16. The composition of claim 14, wherein said solution stable moieties are a reaction product formed from the reaction of:
a first reactant selected from the group consisting of Sulfamic acid, a water soluble Sulfamic acid derivative, an oil soluble Sulfamic acid derivative that can be reacted to provide a water solution stable Sulfamate, and combinations thereof; and,
a second micronutrient and/or macronutrient moiety-including reactant selected from the group consisting of a carbonate, a hydroxide, a carbonate hydroxide, a hydroxide oxide, a metal, and combinations thereof.

17. The composition of claim 15, wherein the solution stable moieties are formed by reacting effective amounts of:
at least one member selected from the group consisting of:
Dolomite, a powdered micronutrient metal, a powdered macronutrient metal, Aragonite (Calcium Carbonate), Artinite (Hydrated Magnesium Carbonate Hydroxide), Aurichalcite (Zinc Copper Carbonate Hydroxide), Azurite (Copper Carbonate Hydroxide), Barringtonite (Hydrated Magnesium Carbonate), Baylissite (Hydrated Potassium Magnesium Carbonate), Brugnatellite (Hydrated Magnesium Iron Carbonate Hydroxide), Butschliite (Potassium Calcium Carbonate), Calcite (Calcium Carbonate), Gaspeite (Nickel Magnesium Iron Carbonate), Magnesite (Magnesium Carbonate), Rhodochrosite (Manganese Carbonate), Siderite (Iron Carbonate), Smithsonite (Zinc Carbonate), Ankerite (Calcium Iron Carbonate), Huntite (Calcium Magnesium Carbonate), Kutnohorite (Calcium Manganese Magnesium Iron Carbonate), Minrecordite (Calcium Zinc Carbonate), Norsethite (Barium Magnesium Carbonate), Fairchildite (Potassium Calcium Carbonate), Georgeite (Hydrated Copper Carbonate Hydroxide), Hellyerite (Hydrated Nickel Carbonate), Hydrozincite (Zinc Carbonate Hydroxide), Ikaite (Hydrated Calcium Carbonate), Kalicinite (Potassium Bicarbonate), Lansfordite (Hydrated Magnesium Carbonate), Loseyite (Manganese Zinc Carbonate Hydroxide), Malachite (Copper Carbonate Hydroxide), Monohydrocalcite (Hydrated Calcium Carbonate), Nesquehonite (Hydrated Magnesium Bicarbonate Hydroxide), Pokrovskite (Hydrated Magnesium Carbonate Hydroxide), Pyroaurite (Hydrated Magnesium Iron Carbonate Hydroxide), Glaukospherite (Copper Nickel Carbonate Hydroxide), Mcguinnessite (Magnesium Copper Carbonate Hydroxide), Nullaginite (Nickel Carbonate Hydroxide), Rosasite (Copper Zinc Carbonate Hydroxide), Zincrosasite (Zinc Copper Carbonate Hydroxide), Sclarite (Zinc Magnesium Manganese Carbonate Hydroxide), Sergeevite (Hydrated Calcium Magnesium Carbonate Bicarbonate Hydroxide), Sjogrenite (Hydrated Magnesium Iron Carbonate Hydroxide), Teschemacherite (Ammonia Bicarbonate), Vaterite (Calcium Carbonate), Zaratite (Hydrated Nickel Carbonate Hydroxide), Tetra-n-butylphosphonium hydroxide, Tetra-n-butylammonium hydroxide, Tetramethylammonium hydroxide, Tetraethylammonium hydroxide, Iron (III) oxyhydroxide, Iron (III) hydroxide (gamma), Iron (III) hydroxide (alpha), Potassium hydroxide, Nickel (II) hydroxide, Hexane-1,6-bis(tributylammonium) dihydroxide, Calcium hydroxide, Tetra-n-propylammonium hydroxide, Tetra-n-butylphosphonium hydroxide, Tetra-n-butylammonium hydroxide, Cobalt (II) hydroxide, Copper (II) carbonate dihydroxide, Copper (II) carbonate (basic), Copper (II) hydroxide, Ammonium hydroxide, Magnesium carbonate hydroxide, Methylboron dihydroxide, Magnesium hydroxide, Molybdenum hydroxide oxide phosphate Calcium phosphate hydroxide, Calcium phosphate tribasic, Calcium hydroxide, Zinc subcarbonate, Zinc carbonate (basic), Zinc carbonate hydroxide, Zinc hydroxide, Potassium bicarbonate, Potassium hydrogen carbonate, Potassium carbonate, Nickel (II) carbonate, Nickel (II) carbonate hydroxide, Nickel (II) carbonate (anhydrous), Nickel (II) carbonate (basic), Manganese (II) carbonate, Magnesium carbonate (basic), Magnesium carbonate hydroxide, Ammonium bicarbonate, Ammonium hydrogen carbonate, Ammonium carbonate, Nickel (II) hydroxide, Calcium phosphate hydroxide, Calcium phosphate tribasic, limestone, Magnesite, lime, slaked lime, magnesium oxide, and/or any combination thereof; and,
at least one sulfamic compound, selected from the group consisting of:
a compound of the formula (II):
HSO₃NR⁴R⁵ (II)
wherein:
R⁴ and R⁵ are independently selected from the group consisting of hydrogen and a monovalent hydrocarbyl group containing from 1 to about 10 carbon atoms; and at least one of R⁴ or R⁵ is hydrogen;
a compound of the formula (III):
R¹(NR²R³)ₙ.nHSO₃NR⁴R⁵ (III)
wherein:
R¹ is selected from the group consisting of alkyl, hydroxyalkyl, cycloalkyl, and aryl,
R² is selected from the group consisting of hydrogen, alkyl, hydroxyalkyl, cycloalkyl and aryl; R³, R⁴ and R⁵ are hydrogen; and n is an integer from 1 to 3; and,
combinations thereof.

18. The composition according to claim 14, further comprising a cell promoting effective amount of water.

19. The composition according to claim 14, wherein said composition is encapsulated.

20. The composition according to claim 14, wherein said cells are selected from the group consisting of living cells, animal cells, plant cells and combinations thereof.
